(19) United States
(12) Patent Application Publication
(10) Pub. No.: US 2011/0215937 A1
(43) Pub. Date: Sep. 8, 2011

(54) Device for Growing Plants on a Vertical Substrate

(76) Inventors: Mary Ellen CARROLL, New York, NY (US); Kevin Topek, Bellaire, TX (US); Carlisle Vandervoort, Houston, TX (US)

(21) Appl. No.: 12/716,995

(22) Filed: Mar. 3, 2010

(51) Int. Cl. A01G 9/02; G08B 21/00

(52) U.S. Cl. 340/604; 47/82; 47/65.8

(57) ABSTRACT

A device for growing plants on a substantially vertical surface includes a carrier and a flexible curtain wall substrate suspended from a track of the carrier. The curtain defines an array of pockets for receiving the plants to be grown and a growing medium, each of the pockets having an opening proximate a top end thereof. A water irrigation system is integrated into the flexible curtain and includes a water emitter for each of the pockets, the water irrigation system being one of connected to and connectable to a water supply. A control system includes moisture sensors connected in each respective pocket. The control system is adapted to activate the water emitters of the pockets.

### BACKGROUND OF THE INVENTION

1. Field of the Invention

This invention relates to a device for growing plants on a substantially vertical surface.

2. Description of the Prior Art

Various horticultural devices are known for growing plants outside the grown soil. The CN 1675983 for example discloses a side slope straw rope curtain, created by bundling several straw ropes to obtain a straw rope bundle, inserting water—retaining agents and composite fertilizer bags into the straw rope bundle, series connecting the straw rope bundles by means of a load-bearing bar so as to obtain a straw rope curtain. On the side slope anchor rods are embedded in the ground, which are interconnected horizontally by a side slope bearing net so as to fix the side slope straw curtain.

### SUMMARY OF THE INVENTION

An objection of the present invention is to provide a ready to use device of simple construction which can be installed indoors and outdoors, in buildings, flats, floors, public spaces and the like, with a vertical substrate for growing plants.

Subject matter of the invention is a device for growing plants on a substantially vertical surface, comprising a curtain wall substrate mounted at its top side in a gliding manner to a transverse carrier, the curtain being provided on one of its surfaces with a plurality of vertically spaced horizontal rows of slotted pockets for receiving the plants to be grown and a growing medium, a water irrigation drip line extending horizontally across each row of pockets and being provided with a water emitter for each pocket, all of the water drip lines being connected to a vertical water supply line extending along one narrow side of the curtain wall substrate, the water supply line being connected to a water pump which in turn is connected to a water supply.

A device of this nature can be installed at any place where a wall of vegetation is desired, both indoors and outdoors.

According to a preferred embodiment of the invention, the curtain wall substrate comprises a flexible shade cloth, to which the pockets and water drip lines are affixed by means of hook and loop fasteners, i.e., Velcro fasteners, or the like.

Each pocket can be provided with a moisture sensor; all of the sensors are linked to a central computer for activating the irrigation system according to a specific program stored in the computer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features of the invention follow from the description of an exemplary embodiment of the invention with reference to the accompanying drawings.

FIG. 1 is a front view of a device according to an embodiment of the invention;

FIG. 2 a rear view of the device of FIG. 1;

FIG. 3 is a perspective view of a closed loop track according to another embodiment of the invention;

FIG. 4 is a detailed front view of one pocket on the device of FIG. 1;

FIG. 5 is a detailed rear view of one pocket on the device of FIG. 1;

FIG. 6 is an exploded view of one pocket of the device of FIG. 1; and

FIG. 7 is sectional view along line VII-VII of the pocket in FIG. 5.

### DETAILED DESCRIPTION OF THE PREFERRED EMBODIMENTS

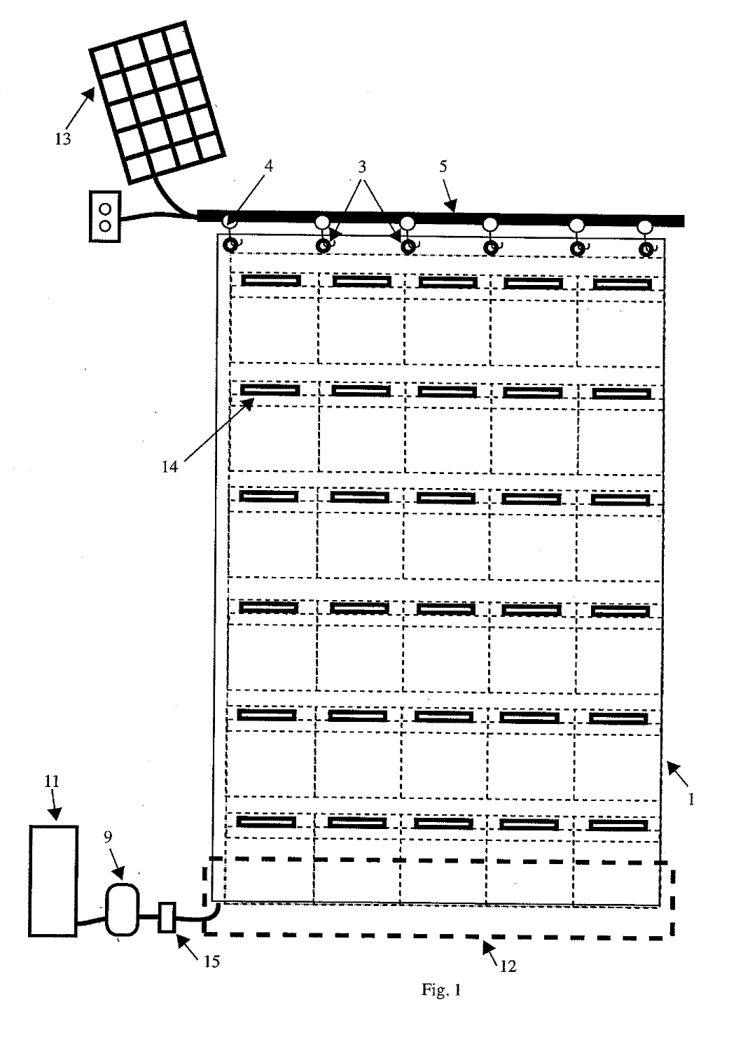

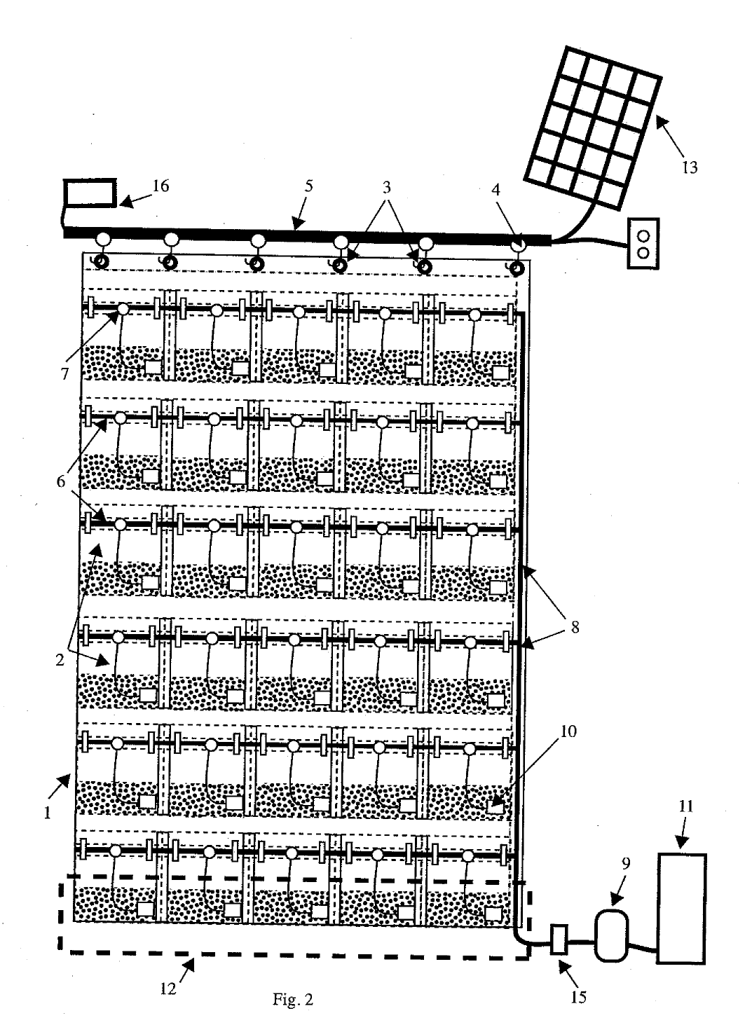

The device depicted in FIGS. 1 and 2 comprises a curtain wall substrate 1 made for example of a flexible shade cloth, such as a recycled plastics material as used in greenhouses. Alternatively, the curtain wall substrate could be any textile fabric such as a woven or knitted cloth. On one of its surfaces, the front surface in FIG. 1, the curtain is provided with vertically spaced apart horizontal rows of adjacent slotted pockets 2 for receiving the vegetation, such as plants and a growing medium, for example polyacrylamide. The pockets 2 are formed, for example, by stitched and/or melted seams holding two separate layers of the textile fabric together. Alternatively, the pockets 2 could be separately formed and each separately fastened to the curtain 1.

The curtain wall substrate 1 is fixed at its top by means of hooks 3 to a series of rollers 4 which run in a track system 5 so that the curtain can be moved in a gliding manner. Alternatively, the curtain wall substrate could be fixed directly to a carrier without a track system. Although hooks 3 are disclosed as the fasteners any known or hereafter developed fasteners may be used to suspend the curtain wall substrate 1 from the track or carrier.

A water irrigation drip line 6 extends horizontally across each row of pockets 2. The water drip lines 6 are provided with water emitters 7, one for each pocket 2, and are at one of their ends connected to a vertical water line 8 extending along one narrow side of the curtain wall substrate 1 to a water pump 9 located at the lower end of the curtain wall. The water pump 9 supplies the drip lines and is connected to a water supply (not shown in FIGS. 1 and 2). The water drip lines 6 and the pockets 2 can be secured to the curtain substrate 1 by means of hook and loop fasteners, so that the pockets 2 can be removed and replaced as needed. Alternatively, the pockets 2 and water drip lines 6 may be integrated in the curtain substrate between to two layers of the curtain substrate. In the latter case, flaps

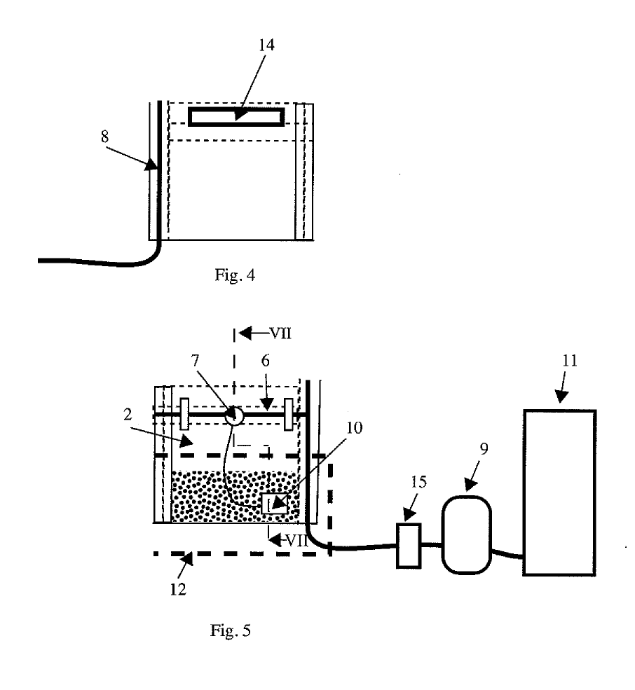

A shown in FIGS. 1 and 4, each pocket 2 includes an opening 14 proximate a top of the pocket 2. This opening 14 or slot provides access for receiving the vegetation, such as plants, and the growing medium (shown as dots in the Figures). It also provides an opening for the plant to grow out of In the embodiment shown, the opening is shown on the front side of the curtain. However, openings 14 could be arranged on both sides of the curtain substrate 1. As further depicted in FIG. 7, the water emitter 7 of each pocket is arranged below the pocket opening 14.

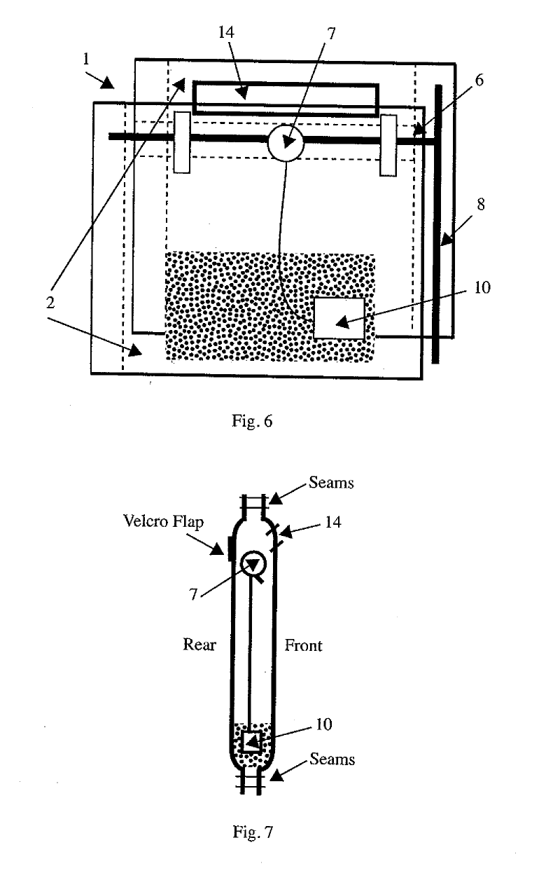

As further shown in FIGS. 5, 6, and 7, each pocket 2 is provided with a moisture sensor 10 which reads the moisture level and transmits the data to a central computer 11 or other controller which activates the drip irrigation system via the pump 9 according to a specific program when necessary or desired. Any excess water from the drip lines 6 which drips down the curtain wall substrate 1 is collected in a water trough 12 extending below the lower end of the curtain wall substrate. The water trough 12 is slightly oblique so that the water accumulates at one end of the trough which is connected to the water pump 9. The central computer could also individually control valves associated with each separate water emitter 7. The water irrigation system could also be controlled manually via the computer 11 or by means of a switch or valve activating the water pump 9. Furthermore, a filter 15 may be arranged in line with the pump 9. As an alternative, the device according to the present invention may be used without a moisture sensor 10. In that case, the rate of the water drip from the water emitter 7 may be manually adjusted at the controller 11, the pump 9, or at individual valves on each water emitter 7.

The trough 12 may comprise any water receptacle and may, for example, comprise a receptacle portion of a rain catchment system.

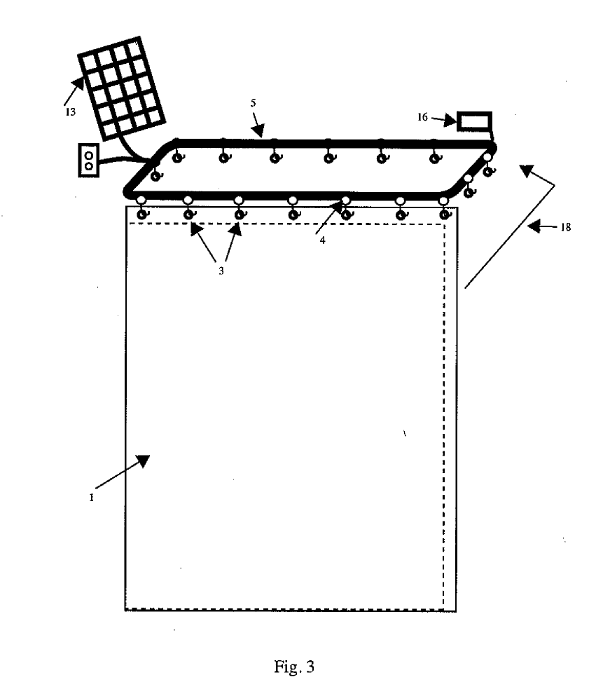

The curtain wall track system 5 can be motorized for moving the curtain wall substrate 1 and powered by a solar panel 13, with a backup generator, or it can be wired for electricity. FIG. 3 shows an embodiment in which the track system 5 is a continuous loop. According to this embodiment, the curtain wall substrate 1 may be moved around the track as required for optimal lighting for the plants, or for optimal privacy, for example, when the curtain is used as an outdoor wall. For example, arrow 18 in FIG. 3 shows one possible path of curtain substrate 1. The track system 5 may also be controlled by the computer system 11.

Further sensors 16, such as temperature and light sensors, may be utilized to determine how the curtain substrate should be moved, i.e., for optimal lighting or other conditions for the plants.

The shown embodiment lends itself to a number of modifications within the scope of the appended claims, in particular as concerns the number and arrangement of the pockets, the mounting of the curtain wall substrate, the material of the curtain and the fixing of the pockets thereto, the control of the irrigation system and so on.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for growing plants on a substantially vertical surface, comprising:
a carrier;
a flexible curtain wall substrate mounted on the carrier, the curtain defining at least one pocket for receiving the plants to be grown and a growing medium; and
a water irrigation system integrated into the flexible curtain and including a water emitter for each said at least one pocket, the water irrigation system being one of connected to and connectable to a water supply.

2. The device of claim 1, wherein the at least one pocket comprises an array of pockets.

3. The device of claim 1, wherein the water irrigation system is connectable to a municipal water supply.

4. The device of claim 1, further comprising a water pump for supplying water to said the water irrigation system.

5. The device of claim 4, further comprising a receptacle holding water, said water pump configured to pump water from said receptacle to said irrigation system.

6. The device of claim 5, wherein the receptacle is arranged below a lower end of the curtain wall substrate such that water falling from the curtain wall substrate is collected in the receptacle, wherein the receptacle comprises one of a trough and a rain catchment system.

7. The device of claim 1, wherein the curtain wall substrate is one of a flexible shade cloth, a woven cloth, and a knitted cloth.

8. The device of claim 1, wherein at least portions of the curtain are openable by releasing reconnectable fasteners to provide access to portions of the irrigation system.

9. The device of claim 1, wherein the reconnectable fasteners are hook and loop fasteners.

10. The device of claim 1, wherein each said at least one pocket includes an opening proximate a top end of the pocket, and said water emitter of said each said at least one pocket is arranged below the opening.

11. The device of claim 1, wherein each said at least one pocket has two openings on opposing sides of said curtain wall substrate.

12. The device of claim 1, wherein the curtain wall substrate is movably arranged on said carrier.

13. The device of claim 1, wherein the curtain wall substrate is slidably suspended from a track in said carrier.

14. The device of claim 13, wherein said track is motorized track for moving the curtain along said track.

15. The device of claim 14, wherein said track comprises a continuous loop.

16. The device of claim 1, further comprising a control system connected to said irrigation system for activating said water emitter of said at least one pocket.

17. The device of claim 16, further comprising a moisture sensor in each said at least one pocket connected to said control system, wherein each said water emitter is controlled in response to an associated moisture sensor.

18. The device of claim 17, further comprising a solar powered power supply providing electric power to said control system.

19. The device of claim 14, further comprising a control system and at least one of a light sensor and a temperature sensor arranged on said curtain wall substrate, wherein said controller controls movement of said curtain wall substrate along said track in response to signals from said at least one of a light sensor and a temperature sensor.

20. A device for growing plants on a substantially vertical surface, comprising:
a carrier having a motorized track;
a flexible curtain wall substrate movably suspended from the track of the carrier, the curtain defining an array of pockets for receiving the plants to be grown and a growing medium, each said pockets having an opening proximate a top end thereof;
a water irrigation system integrated into the flexible curtain and including a water emitter for each of said pockets, the water irrigation system being one of connected to and connectable to a water supply;
a control system including moisture sensors connected in each respective pocket, said control system adapted to activate the water emitters of said pockets and said motorized track.
